(19) United States
(12) Patent Application Publication
(10) Pub. No.: US 2019/0107794 A1
(43) Pub. Date: Apr. 11, 2019

(54) LIQUID DEVELOPER AND METHOD FOR PRODUCING LIQUID DEVELOPER

(71) Applicant: CANON KABUSHIKI KAISHA, Tokyo (JP)

(72) Inventors: Yuzo Tokunaga, Chiba-shi (JP); Yasutaka Akashi, Yokohama-shi (JP); Naohiko Tsuchida, Tokyo (JP); Junji Ito, Hiratsuka-shi (JP); Yasuhiro Aichi, Tokyo (JP); Jun Shirakawa, Kawaguchi-shi (JP); Ryo Natori, Tokyo (JP); Waka Hasegawa, Tokyo (JP); Ayano Mashida, Kawasaki-shi (JP)

(21) Appl. No.: 16/216,058

(22) Filed: Dec. 11, 2018

Related U.S. Application Data
(63) Continuation of application No. PCT/JP2017/021820, filed on Jun. 13, 2017.

(30) Foreign Application Priority Data
Jun. 14, 2016 (JP) 2016-117989

(51) Int. Cl. G03G 9/13; G03G 9/125; G03G 9/12; G03G 15/10

(52) U.S. Cl. CPC G03G 9/13; G03G 15/10; G03G 9/122; G03G 9/125

(57) ABSTRACT

The liquid developer according to the present invention includes a toner particle containing a polyester resin and a pigment and includes a carrier liquid comprising a nonaqueous solution, the polyester resin contains a monomer unit derived from trimellitic acid, and the content of the monomer unit derived from trimellitic acid in the total acid component-derived monomer unit constituting the polyester resin is from 2.0 mol % to 60.0 mol %, the polyester resin also contains a monomer unit derived from an ethylene oxide adduct on bisphenol A, and the content of the monomer unit derived from the ethylene oxide adduct on bisphenol A in the total alcohol component-derived monomer unit constituting the polyester resin is from 50.0 mol % to 100.0 mol %, and the average circularity of the toner particle is at least 0.950.

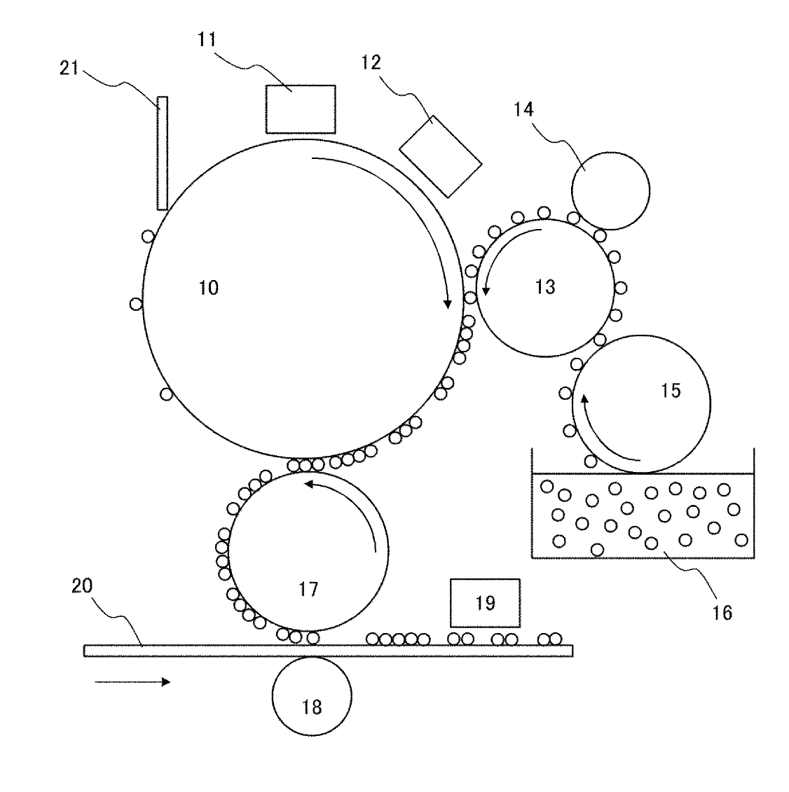

### CROSS-REFERENCE TO RELATED APPLICATIONS

This application is a Continuation of International Patent Application No. PCT/JP2017/021820, filed Jun. 13, 2017, which claims the benefit of Japanese Patent Application No. 2016-117989, filed Jun. 14, 2016, both of which are hereby incorporated by reference herein in their entirety.

### BACKGROUND OF THE INVENTION

### Field of the Invention

The present invention relates to the liquid developer used in image-forming apparatuses that employ an electrophotographic system. The present invention further relates to a method for producing the liquid developer.

### Background Art

Higher color image quality and higher machine speeds have in recent years been desired from image-forming apparatuses that utilize electrophotographic systems, e.g., copiers, facsimile machines, printers, and so forth. Within this context, development is being actively pursued into high image quality, high-speed digital printers that utilize electrophotographic technology that uses liquid developers, which exhibit a good high-definition dot reproducibility, fine line image reproducibility, and gradation reproducibility, an excellent color reproducibility, and an excellent capacity for high-speed image formation.

Liquid developers having toner particles, in the form of colored resin fine particles, dispersed in a carrier liquid are already known as liquid developers. Nonaqueous insulating liquids, e.g., hydrocarbon-type organic solvents, silicone oils, and so forth, are generally used as the carrier liquid because, for example, they do not perturb the potential of the electrostatic latent image on the photosensitive drum and they are resistant to volatilization during storage.

Polyester resins are commonly used as the resin for forming the toner particle, based on considerations of production costs, the light transmittance and stability in carrier liquids, and the thermoplasticity when the same heat- and pressure-mediated fixing method as in dry development systems is used.

In order to avoid impairment of the heat- and pressure-mediated fixability of the toner particle due to infiltration of the carrier liquid into the interior of the toner and due to the influence of the dispersing agent, PTL 1 proposes a developer that is produced using a basic polymeric dispersing agent and a polyester resin that uses trimellitic acid as a polybasic carboxylic acid.

In PTL 2, on the other hand, a liquid developer is proposed that uses a small diameter from 1 μm to 3 μm for the toner particle in order to achieve an increased image quality and that uses an average toner particle circularity from 0.90 to 0.96 in order to raise the cleaning performance.

### CITATION LIST

### Patent Literature

PTL 1 Japanese Patent No. 5,293,029

PTL 2 Japanese Patent Application Laid-open No. 2014-163985

In order to develop an electrophotography system-based image-forming apparatus that uses liquid developer and provides a high image quality, the toner particles must faithfully reproduce the electrostatic latent image on the photosensitive drum. Due to this, the toner particles must easily flow in the carrier liquid and exhibit conformability to the electrostatic latent image on the surface of the photosensitive drum.

PTL 1 discloses a developer having a toner particle that contains a polyester resin that contains phthalic acid and trimellitic acid as constituent components. This toner particle exhibits a stable dispersion in the carrier liquid and exhibits an excellent heat- and pressure-mediated fixing performance. However, this toner particle has an irregular shape due to the use of the pulverization method, and further improvements are required in order to obtain an excellent electrostatic latent image reproducibility.

In addition, liquid developer that uses the toner particle described in PTL 2 cannot secure an adequate conformability to high-definition latent images, i.e., 600 dpi and above, on the photosensitive drum.

The present invention therefore provides a liquid developer that exhibits an excellent electrostatic latent image reproducibility and yields a high-quality image and also provides a method for producing the liquid developer.

### SUMMARY OF THE INVENTION

The present invention relates to a liquid developer including a toner particle that contains a polyester resin and a pigment and including a carrier liquid comprising a nonaqueous solution, wherein

the polyester resin contains, as an acid component, a monomer unit derived from trimellitic acid;

the content of the monomer unit derived from trimellitic acid in the total acid component-derived monomer unit constituting the polyester resin is from 2.0 mol % to 60.0 mol %;

the polyester resin contains, as an alcohol component, a monomer unit derived from an ethylene oxide adduct on bisphenol A;

the content of the monomer unit derived from the ethylene oxide adduct on bisphenol A in the total alcohol component-derived monomer unit constituting the polyester resin is from 50.0 mol % to 100.0 mol %; and

the average circularity of the toner particle is at least 0.950.

The present invention further relates to a method for producing a liquid developer containing a toner particle that contains a polyester resin and a pigment and containing a carrier liquid comprising a nonaqueous solution, wherein the method contains

a pigment dispersion step of preparing a pigment dispersion that contains the polyester resin, the pigment, and a solvent;

a mixing step of adding, to the pigment dispersion, a carrier liquid comprising the nonaqueous solution to prepare a mixture; and

a distillative removal step of distillatively removing the solvent from the mixture, wherein

the polyester resin contains, as an acid component, a monomer unit derived from trimellitic acid;

the content of the monomer unit derived from trimellitic acid in the total acid component-derived monomer unit constituting the polyester resin is from 2.0 mol % to 60.0 mol %;

the polyester resin contains, as an alcohol component, a monomer unit derived from an ethylene oxide adduct on bisphenol A;

the content of the monomer unit derived from the ethylene oxide adduct on bisphenol A in the total alcohol component-derived monomer unit constituting the polyester resin is from 50.0 mol % to 100.0 mol %; and

the average circularity of the toner particle is at least 0.950.

Further features of the present invention will become apparent from the following description of exemplary embodiments with reference to the attached drawings.

### BRIEF DESCRIPTION OF THE DRAWINGS

The FIGURE is a schematic structural diagram of the essential features of an image-forming apparatus.

### DESCRIPTION OF THE EMBODIMENTS

Unless specifically indicated otherwise, the expressions “from XX to YY” and “XX to YY” that show numerical value ranges refer in the present invention to numerical value ranges that include the lower limit and upper limit that are the end points.

The liquid developer according to the present invention contains a carrier liquid comprising a nonaqueous solution and contains a toner particle that contains a polyester resin and a pigment.

This polyester resin contains, as an acid component, a monomer unit derived from trimellitic acid, and

the content of the monomer unit derived from trimellitic acid in the total acid component-derived monomer unit constituting the polyester resin is from 2.0 mol % to 60.0 mol %.

In addition, this polyester resin contains, as an alcohol component, a monomer unit derived from an ethylene oxide adduct on bisphenol A, and

the content of the monomer unit derived from the ethylene oxide adduct on bisphenol A in the total alcohol component-derived monomer unit constituting the polyester resin is from 50.0 mol % to 100.0 mol %.

Here, monomer unit refers to the state of the reacted monomer material in the polymer or resin.

By having the content of the monomer unit derived from trimellitic acid in the total acid component-derived monomer unit constituting the polyester resin be from 2.0 mol % to 60.0 mol %, softening or swelling of the toner particle surface by the carrier liquid comprising a nonaqueous solution is inhibited and movement in the carrier liquid is facilitated. Moreover, the adhesive force between the toner particle and the photosensitive drum surface during the developing process is attenuated and the ability to conform to the electrostatic latent image is improved and as a result the dot reproducibility is enhanced.

Viewed from the perspective of achieving additional enhancements in the dot reproducibility, the content of the monomer unit derived from trimellitic acid is preferably from 2.0 mol % to 30.0 mol %.

On the other hand, a low affinity with the carrier liquid comprising a nonaqueous solution is established by having the content of the monomer unit derived from the ethylene oxide adduct on bisphenol A in the total alcohol component-derived monomer unit constituting the polyester resin be from 50.0 mol % to 100.0 mol %. As a result, the effect of inhibiting the aforementioned softening or swelling of the toner particle surface is substantially enhanced and an improved dot reproducibility is obtained.

Viewed from the perspective of achieving additional enhancements in the dot reproducibility, the content monomer unit derived from the ethylene oxide adduct on bisphenol A is preferably from 80.0 mol % to 100.0 mol %.

In order to achieve additional enhancements in the dot reproducibility, the average number of moles of ethylene oxide addition in the monomer unit derived from the ethylene oxide adduct on bisphenol A is preferably from 1.0 mole to 3.0 moles and is more preferably from 2.0 moles to 3.0 moles.

By having this average number of moles of addition be from 1.0 mol to 3.0 moles, the inhibitory effect on the aforementioned softening or swelling of the toner particle surface is then obtained in a stable manner and an excellent dot reproducibility-improving effect is obtained.

The average circularity of the toner particle is from 0.950 to 1.000. By having the average circularity of the toner particle be at least 0.950, adhesion to the photosensitive drum surface is inhibited and the conformability to the electrostatic latent image is improved. In order to bring about additional improvements in the conformability to the electrostatic latent image, the average circularity of the toner particle is more preferably from 0.965 to 1.000 and is still more preferably from 0.970 to 1.000.

The average particle diameter on a volume basis (D50) of the toner particle is preferably from 0.1 μm to 2.0 μm and is more preferably from 1.0 to 1.5 μm. The resolution of the toner image formed by the liquid developer can be brought to a satisfactorily high level when the average particle diameter of the toner particle is a value in the indicated range.

The polyester resin constituting the toner particle uses, as starting materials, at least trimellitic acid for the acid component and at least an ethylene oxide adduct on bisphenol A for the alcohol component. However, other polybasic carboxylic acids and other polyhydric alcohols may also be used in combination therewith as constituent components of the polyester resin as long as the preceding stipulations are satisfied. In addition, the polycondensation reaction that produces the polyester resin may also use a derivative of trimellitic acid or a derivative of the bisphenol A/ethylene oxide adduct that provides the same resin structure as for the use of trimellitic acid or the bisphenol A/ethylene oxide adduct. Such derivatives can be exemplified by anhydrides, esters, and chlorides.

The polybasic carboxylic acid can be exemplified by the following: aromatic dicarboxylic acids such as phthalic acid, isophthalic acid, and terephthalic acid and their anhydrides; alkyl dicarboxylic acids such as succinic acid, adipic acid, sebacic acid, and azelaic acid and their anhydrides; succinic acid substituted by an alkyl group or alkenyl group having 6 to 18 carbons, and anhydrides thereof; unsaturated dicarboxylic acids such as fumaric acid, maleic acid, and citraconic acid and their anhydrides; and pyromellitic acid and benzophenonetetracarboxylic acid and anhydrides thereof.

The polyhydric alcohol can be exemplified by the following:

adducts on bisphenol A by an alkylene oxide other than ethylene oxide, and also ethylene glycol, diethylene glycol, triethylene glycol, 1,2-propanediol, 1,3-propanediol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, polytetramethylene glycol, bisphenol A, hydrogenated bisphenol A, sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butanetriol, trimethylolethane, trimethylolpropane, and 1,3,5-trihydroxymethylbenzene.

The polyester resin constituting the toner particle in the liquid developer may contain a plurality of polyester resins or modified polyester resins obtained from the aforementioned starting materials.

In addition, to the extent that the effects of the present invention are not impaired, the toner particle may also use other resins in combination with the polyester resin.

These other resins can be exemplified by homopolymers of styrene and its substituted forms, e.g., polystyrene, poly-p-chlorostyrene, and polyvinyltoluene; styrene copolymers, e.g., styrene-p-chlorostyrene copolymer, styrene-vinyltoluene copolymer, styrene-vinylnaphthalene copolymer, styrene-acrylate ester copolymers, styrene-methacrylate ester copolymers, styrene-methyl α-chloromethacrylate copolymer, styrene-acrylonitrile copolymer, styrene-vinyl methyl ether copolymer, styrene-vinyl ethyl ether copolymer, styrene-vinyl methyl ketone copolymer, and styrene-acrylonitrile copolymer; as well as polyvinyl chloride, phenolic resins, natural resin-modified phenolic resins, natural resin-modified maleic acid resins, acrylic resins, methacrylic resins, polyvinyl acetate, silicone resins, polyurethane, polyamide resins, furan resins, epoxy resins, xylene resins, polyvinyl butyral, terpene resins, coumarone-indene resins, and petroleum resins.

The toner particle concentration in the liquid developer can be freely adjusted in accordance with the image-forming apparatus that is used, but may be approximately 1 mass % to 70 mass %.

The toner particle in the liquid developer may contain a wax in order to raise the fixing performance. There are no particular limitations on this wax, and known waxes may be used in known contents.

The toner particle contains a pigment. There are no particular limitations on this pigment, and any generally commercially available organic pigment and inorganic pigment can be used, as can a pigment dispersed in, for example, an insoluble resin as a dispersion medium for the pigment as well as pigments provided by grafting a resin onto the pigment surface.

These organic pigments and inorganic pigments can be specifically exemplified by the following.

The following are examples of pigments that exhibit a yellow color:

C. I. Pigment Yellow 1, 2, 3, 4, 5, 6, 7, 10, 11, 12, 13, 14, 15, 16, 17, 23, 62, 65, 73, 74, 83, 93, 94, 95, 97, 109, 110, 111, 120, 127, 128, 129, 147, 151, 154, 155, 168, 174, 175, 176, 180, 181, and 185, and C. I. Vat Yellow 1, 3, and 20.

The following are examples of pigments that exhibit a red or magenta color:

C. I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48:2, 48:3, 48:4, 49, 50, 51, 52, 53, 54, 55, 57:1, 58, 60, 63, 64, 68, 81:1, 83, 87, 88, 89, 90, 112, 114, 122, 123, 146, 147, 150, 163, 184, 202, 206, 207, 209, 238, and 269; C. I. Pigment Violet 19; and C. I. Vat Red 1, 2, 10, 13, 15, 23, 29, and 35.

The following are examples of pigments that exhibit a blue or cyan color:

C. I. Pigment Blue 2, 3, 15:2, 15:3, 15:4, 16, and 17; C. I. Vat Blue 6; C. I. Acid Blue 45; and copper phthalocyanine pigments in which 1 to 5 phthalimidomethyl groups are substituted on the phthalocyanine skeleton.

The following are examples of pigments that exhibit a green color:

C. I. Pigment Green 7, 8, and 36 .

The following are examples of pigments that exhibit an orange color:

C. I. Pigment Orange 66 and 51.

The following are examples of pigments that exhibit a black color: carbon black, titanium black, and aniline black.

The following are examples of pigments that exhibit a white color: basic lead carbonate, zinc oxide, titanium oxide, and strontium titanate.

Dispersing means corresponding to the toner particle production method may be used to disperse the pigment in the toner particle. Examples of devices that can be used as the dispersing means are the ball mill, sand mill, attritor, roll mill, jet mill, homogenizer, paint shaker, kneader, agitator, Henschel mixer, colloid mill, ultrasound homogenizer, pearl mill, and wet jet mill.

A pigment dispersing agent may also be added when pigment dispersion is carried out. The pigment dispersing agent can be exemplified by the esters of hydroxyl group-bearing carboxylic acids, the salts of high molecular weight acid esters and long-chain polyaminoamides, the salts of high molecular weight polycarboxylic acids, esters of high molecular weight unsaturated acids, high molecular weight copolymers, polyesters and modifications thereof, modified polyacrylates, aliphatic polybasic carboxylic acids, naphthalenesulfonic acid/formalin condensates, polyoxyethylenealkyl phosphate esters, and pigment derivatives.

A synergist corresponding to various pigments may also be used as a pigment dispersion auxiliary.

The amount of addition of these pigment dispersing agents and pigment dispersion auxiliaries is preferably from 1 mass part to 50 mass parts per 100 mass parts of the pigment.

The liquid developer can contain a toner particle dispersing agent in order to effect a stable dispersion of the toner particle. This toner particle dispersing agent can be exemplified by the commercial products Ajisper PB817 (Ajinomoto Co., Inc.) and Solsperse 11200, 13940, 17000, and 18000 (Lubrizol Japan Ltd.).

This toner particle dispersing agent is preferably a toner particle dispersing agent A, i.e., a polymer that contains at least both the monomer unit represented by the general formula (A) below and the monomer unit represented by the general formula (B) below, wherein this dispersing agent has the monomer unit with general formula (A) at a position other than terminal position. The aforementioned Ajisper PB817 (reaction product of a polyallylamine and the self-condensate of 12-hydroxystearic acid) corresponds to this toner particle dispersing agent A.

The aforementioned Solsperse 13940 (other than the amino group in terminal position, all of the amino groups obtained for the reaction product of a 12-hydroxystearic acid self-condensate and a polyethylenepolyamine are either a secondary amino group or tertiary amino group. That is, it does not have a primary amino group at other than terminal position.), on other hand, does not correspond to this toner particle dispersing agent A.

K formula (A)

[In formula (A), K is a monomer unit that has a primary amino group.]

Q formula (B)

[In formula (B), Q is a monomer unit that has a possibly substituted alkyl group having at least 6 carbons, a possibly substituted cycloalkyl group having at least 6 carbons, a possibly substituted alkylene group having at least 6 carbons, or a possibly substituted cycloalkylene group having at least 6 carbons.]

The content of this toner particle dispersing agent is preferably from 0.5 mass parts to 20 mass parts per 100 mass parts of the polyester resin.

The liquid developer contains a carrier liquid comprising a nonaqueous solution.

This nonaqueous solution should be a liquid that exhibits a high volume resistivity, an electrical insulating behavior, and a low viscosity around room temperature, but is not otherwise particularly limited.

For example, a hydrocarbon-type organic solvent, e.g., an isoparaffinic solvent, or a silicone oil can be suitably used as the nonaqueous solution; however, in order to achieve a further increase in the dot reproducibility of the toner particle, a curable carrier liquid may be used while not imparting fixability to the toner particle.

In addition, the nonaqueous solution is preferably selected from liquids that do not dissolve the polyester resin present in the toner particle.

In specific terms, a nonaqueous solution is preferably selected that does not dissolve more than 1 mass part of the polyester resin per 100 mass parts of the nonaqueous solution at a temperature of 25° C.

The carrier liquid can be selected from polymerizable liquid monomers when a curable carrier liquid is used. The polymerizable liquid monomer can be exemplified by acrylic monomers, vinyl ether compounds, and cyclic ether monomers such as epoxides and oxetanes.

Among the preceding, vinyl ether compounds are preferred from the standpoint of human safety, high resistance, and low viscosity.

This vinyl ether compound refers to a compound having the vinyl ether structure (—CH═CH—O—C—).

The vinyl ether structure is preferably represented by R′—CH=CH—O—C— (R′ is the hydrogen atom or an alkyl group having 1 to 3 carbons and is preferably the hydrogen atom or methyl group).

The vinyl ether compound is preferably represented by the following formula (C).

(H₂C═CH—O)ₙ—R formula (C)

[In formula (C), n represents the number of vinyl ether structures in a single molecule and is an integer from 1 to 4. R is an n-valent hydrocarbon group.]

This n is preferably an integer from 1 to 3.

R is preferably a group selected from linear or branched, saturated or unsaturated aliphatic hydrocarbon groups having from 1 to 20 carbons, saturated or unsaturated alicyclic hydrocarbon groups having from 5 to 12 carbons, and aromatic hydrocarbon groups having from 6 to 14 carbons, and the alicyclic hydrocarbon groups and aromatic hydrocarbon groups may have a saturated or unsaturated aliphatic hydrocarbon group having from 1 to 4 carbons.

R is more preferably a linear or branched saturated aliphatic hydrocarbon group having from 4 to 18 carbons.

The vinyl ether compound can be exemplified by n-octyl vinyl ether, 2-ethylhexyl vinyl ether, dodecyl vinyl ether, octadecyl vinyl ether, benzyl vinyl ether, dicyclopentadiene vinyl ether, cyclohexanedimethanol divinyl ether, tricyclodecane vinyl ether, trimethylolpropane trivinyl ether, 2-ethyl-1,3-hexanediol divinyl ether, 2,4-diethyl-1,5-pentanediol divinyl ether, 2-butyl-2-ethyl-1,3-propanediol divinyl ether, neopentyl glycol divinyl ether, pentaerythritol tetravinyl ether, 1,2-decanediol divinyl ether, and dipropylene glycol divinyl ether.

The polymerizable monomer may also be used in combination with a photopolymerization initiator when the carrier liquid of the liquid developer is to be cured using light energy, e.g., ultraviolet radiation.

The photopolymerization initiator is a compound that generates an acid or radical when impinged by light at a prescribed wavelength. Such compounds can be exemplified by cationic photopolymerization initiators such as onium salt compounds, sulfone compounds, sulfonate ester compounds, sulfonimide compounds, and diazomethane compounds, but there is no limitation to or by these. Benzoin derivatives are examples of radical photopolymerization initiators, but there is no limitation to or by these.

Moreover, when a cationic photopolymerization initiator is used, the use is preferred of a photopolymerization initiator represented by the following formula (1), which causes little reduction in the volume resistivity of the carrier liquid.

The content of the photopolymerization initiator is not particularly limited, but, expressed per 100 mass parts of the polymerizable liquid monomer, is preferably from 0.01 mass parts to 5 mass parts, more preferably from 0.05 mass parts to 1 mass part, and still more preferably from 0.1 mass parts to 0.5 mass parts.

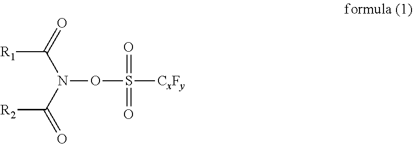

[In formula (1), Ri and R2 are bonded to each other to form a ring structure, x represents an integer from 1 to 8, and y represents an integer from 3 to 17.]

A sensitizer may optionally be added in combination with the photopolymerization initiator with the goal of, e.g., improving the acid-generating efficiency of the photopolymerization initiator, extending the photosensitive wavelength to longer wavelengths, and so forth.

A polymerization inhibitor may also be added in order to avoid the initiation of the polymerization prior to exposure of the curable carrier liquid to the prescribed light energy. Cationic polymerization inhibitors can be exemplified by alkali metal compounds and/or alkaline-earth metal compounds, and by amines.

Radical polymerization inhibitors can be exemplified by phenolic hydroxyl group-bearing compounds; quinones such as methoquinone (hydroquinone monomethyl ether), hydroquinone, and 4-methoxy-1-naphthol; hindered aminic antioxidants; 1,1-diphenyl-2-picrylhydrazyl free radical; N-oxyl free radical compounds; nitrogenous heterocyclic mercaptan compounds; thioether antioxidants; hindered phenolic antioxidants; ascorbic acids; zinc sulfate; thiocyanates; thiourea derivatives; various sugars; phosphoric acid-based antioxidants; nitrites; sulfites; thiosulfates; hydroxylamine derivatives; aromatic amines; phenylenediamines; imines; sulfonamides; urea derivatives; oximes; polycondensates between dicyandiamide and polyalkylenepolyamine; sulfur-containing compounds such as phenothiazine; complexing agents based on tetraazaannulene (TAA); and hindered amines.

The liquid developer may optionally contain a charge control agent. Known charge control agents can be used as this charge control agent.

The following are examples of specific compounds:

fats and oils such as linseed oil and soybean oil; alkyd resins; halogen polymers; aromatic polycarboxylic acids; acidic group-containing water-soluble dyes; oxidative condensates of aromatic polyamines; metal soaps such as cobalt naphthenate, nickel naphthenate, iron naphthenate, zinc naphthenate, cobalt octylate, nickel octylate, zinc octylate, cobalt dodecylate, nickel dodecylate, zinc dodecylate, aluminum stearate, and cobalt 2-ethylhexanoate; sulfonate metal salts such as petroleum metal sulfonates and metal salts of sulfosuccinate esters; phospholipids such as lecithin and hydrogenated lecithin; metal salicylate salts such as metal complexes of t-butylsalicylic acid; as well as polyvinylpyrrolidone resins, polyamide resins, sulfonic acid-containing resins, and hydroxybenzoic acid derivatives.

The liquid developer may also optionally incorporate other additives besides those discussed in the preceding.

The method for producing the toner particle is not particularly limited and can be exemplified by known methods, e.g., pulverization methods such as dry pulverization methods and wet pulverization methods; polymerization methods such as suspension polymerization methods, emulsion polymerization methods, dispersion polymerization methods, and interfacial polymerization methods; as well as phase inversion emulsification methods and dissolution suspension methods.

The method according to the present invention for producing the liquid developer is a method for producing a liquid developer that contains a carrier liquid comprising a nonaqueous solution and contains a toner particle that contains a polyester resin and a pigment, wherein the method contains

a pigment dispersion step of preparing a pigment dispersion that contains the polyester resin, the pigment, and a solvent;

a mixing step of adding, to the pigment dispersion, a carrier liquid comprising the nonaqueous solution to prepare a mixture; and

a distillative removal step of distillatively removing the solvent from the mixture, wherein

the polyester resin contains, as an acid component, a monomer unit derived from trimellitic acid;

the content of the monomer unit derived from trimellitic acid in the total acid component-derived monomer unit constituting the polyester resin is from 2.0 mol % to 60.0 mol %;

the polyester resin contains, as an alcohol component, a monomer unit derived from an ethylene oxide adduct on bisphenol A;

the content of the monomer unit derived from the ethylene oxide adduct on bisphenol A in the total alcohol component-derived monomer unit constituting the polyester resin is from 50.0 mol % to 100.0 mol %; and

the average circularity of the toner particle is at least 0.950.

This liquid toner production method is described in the following.

[The Pigment Dispersion Step]

A pigment dispersion containing the polyester resin, the pigment, and a solvent is first prepared. The aforementioned pigment dispersing agent is preferably incorporated in this pigment dispersion in order to provide an excellent pigment dispersibility in the resulting toner particle. In addition, the aforementioned toner particle dispersing agent is preferably incorporated in order to increase the dispersion stability of the toner particle in the nonaqueous solution, vide infra. The solvent should be able to dissolve the polyester resin.

The method for preparing this pigment dispersion can be exemplified by the following:

methods in which the dispersion is obtained by melt-kneading the pigment and polyester resin using a heated three-roll mill and then dissolving the melt-kneaded material in the solvent; and

methods in which the pigment, pigment dispersing agent, and solvent are mixed, a wet dispersion of the pigment is carried out using a media-based disperser such as an attritor, ball mill, sand mill, and so forth, or using a media-free disperser such as a high-speed mixer, high-speed homogenizer, and so forth, followed by the addition of a mixture of the solvent, polyester resin, and toner particle dispersing agent and mixing and dispersing using a high-speed disperser to obtain the pigment dispersion.

The content of the polyester resin with reference to the solvent, expressed per 100 mass parts of the solvent, is preferably from 5 mass parts to 150 mass parts of the polyester resin and is more preferably from 10 mass parts to 75 mass parts of the polyester resin.

The content of the polyester resin with reference to the pigment, expressed per 1 mass part of the pigment, is preferably from 1 mass part to 20 mass parts of the polyester resin and is more preferably from 3 mass parts to 10 mass parts of the polyester resin.

[The Mixing Step]

A mixing step is carried out following the pigment dispersion step. A mixture is prepared in this mixing step by adding, to the pigment dispersion provided by the pigment dispersion step, a carrier liquid comprising a nonaqueous solution that does not dissolve the polyester resin. Through the addition of the carrier liquid comprising a nonaqueous solution that does not dissolve the polyester resin, a phase separation occurs and the polyester resin precipitates while enclosing the pigment.

The nonaqueous solution is preferably added in this mixing step up to and including phase separation of the polyester resin. This “phase separation of the polyester resin” is considered to be that “the polyester resin has undergone phase separation” at the point when a white cloudiness can be observed when the nonaqueous solution is added to the resin solution in which the polyester resin is dissolved.

A high-speed shear force is preferably applied in this mixing step during the addition of the nonaqueous solution. The high-speed shear apparatus should apply a stirring shear but is not otherwise particularly limited, and, for example, a homogenizer, homomixer, and so forth can be used. A variety of apparatuses having different, e.g., capacities, rotation rates, configurations, and so forth, are available, and an apparatus should be used that is adapted to the particular production modality. When a homogenizer is used, the rotation rate is preferably at least 500 rpm.

The temperature of the mixing step is preferably above the freezing points and below the boiling points of the solvent and nonaqueous solution. The range from 0° C. to 60° C. is specifically preferred.

The average circularity of the toner particle may be adjusted into the aforementioned range by adjusting the type and amount of addition of the toner particle dispersing agent and by adjusting the stirring shear (adjusted using, for example, the rotation rate of the high-speed shear apparatus) in the mixing step.

[The Distillative Removal Step]

The mixing step is followed by the distillative removal of the solvent from the mixture yielded by the mixing step. Evaporation and so forth is suitable for the method of distillatively removing the solvent. For example, the solvent may be distillatively removed under a reduced pressure of 1 to 200 hPa at 0° C. to 60° C.

The liquid developer may be prepared by the addition of the optional additives, e.g., photopolymerization initiator, charge control agent, and so forth, to the toner particle dispersion provided by the distillative removal step.

There are no particular limitations on the method for adding the additives such as the photopolymerization initiator and charge control agent, but heating and stirring should be carried out as appropriate depending on the type of additive. As appropriate, production of the liquid developer may be provided with additional unit processes, e.g., washing of the toner particle.

The solvent should dissolve the polyester resin, but is not otherwise particularly limited and can be exemplified by ethers such as tetrahydrofuran, ketones such as methyl ethyl ketone and cyclohexanone, esters such as ethyl acetate, and halides such as chloroform. This may also be an aromatic hydrocarbon, e.g., toluene, benzene, and so forth, when the capacity to dissolve the polyester resin is present.

The SP values of the polyester resin, solvent, and nonaqueous solution preferably increase in the sequence of nonaqueous solution, solvent, and polyester resin, and the difference between the SP values of the polyester resin and solvent is preferably at least 2.5. The SP value (solubility parameter, unit: (cal/cm³)^{1/2}) is a factor that governs the solubility between the polyester resin and solvent. The trend with polyester resins, which generally exhibit polarity, is that they readily dissolve in polar solvents and are poorly soluble in nonpolar solvents. On the other hand, the opposite trend applies with nonpolar resins. The solubility parameter (SP value), represented by δ, is a factor that discriminates the strength of this affinity. In general, a smaller difference in SP value between a solvent and solute indicates a larger solubility. The definition of the SP value and its method of calculation are described in, for example, “IUPAC COMPENDIUM OF CHEMICAL TERMINOLOGY Gold Book (Version 2.3.3, Feb. 24, 2014), solubility parameter, δ (page 1397)”.

The analytical methods and measurement methods used for the properties in the present invention are described in the following.

### <Analysis 1 of the Polyester Resin Constituting the Toner Particle>

The toner particle is separated from the liquid developer by centrifugal separation and washing.

Specifically, 50 mL of the liquid developer is introduced into a centrifuge tube and centrifugal separation is carried out using a centrifugal separator (Allegra 64R Centrifuge, Beckman Coulter, Inc.) and conditions of 15,000 rpm and 10 minutes.

Sedimentation of the toner particle is confirmed; the supernatant is removed by decantation; and hexane is added in the same amount as the supernatant that has been removed. A thorough washing by the hexane is performed by stirring for 5 minutes with a spatula, and centrifugal separation is subsequently carried out again using the same conditions. After hexane has been added and removed three times, the hexane is evaporated at room temperature to obtain the toner particles.

The toner particles are dissolved in deuterochloroform and compositional analysis of the polyester resin constituting the toner particles is then performed using a JNM-ECA (¹H-NMR), a Fourier-transform nuclear magnetic resonance instrument from JEOL Ltd.

<Analysis 2 of the Polyester Resin Constituting the Toner Particle>

The obtained toner particles are dissolved in tetrahydrofuran and the molecular weight of the polyester resin constituting the toner particles is measured using an HLC8120 GPC (detector: RI) (Tosoh Corporation).

<Measurement of the Average Circularity of the Toner Particle>

The average circularity of the toner particle is measured using an “FPIA-3000” (Sysmex Corporation) flow-type particle image analyzer in accordance with the operating manual provided with the instrument.

The specific measurement procedure is as follows.

0.02 g of an alkylbenzenesulfonate salt is added as dispersing agent to 20 mL of deionized water; 0.02 g of the measurement sample is then added; and a dispersion treatment is carried out for 2 minutes using a “VS-150” (Velvo-Clear Co., Ltd.) benchtop ultrasound cleaner/disperser having an oscillation frequency of 50 kHz and an electrical output of 150 W to provide a dispersion to be used for the measurement. Cooling is carried out as appropriate during this process in order to have the temperature of the dispersion be from 10° C. to 40° C.

The previously cited flow particle image analyzer fitted with an objective lens (10×) is used for the measurement, and “PSE-900A” (Sysmex Corporation) particle sheath is used for the sheath solution. The dispersion prepared according to the procedure described above is introduced into the flow particle image analyzer and 3,000 of the toner particles are measured according to total count mode in HPF measurement mode. The average circularity of the toner particles is determined with the binarization threshold value during particle analysis set at 85% and with the analyzed particle diameter limited to a circle-equivalent diameter of from 0.25 μm to 10 μm.

<Measurement of the Acid Value/Hydroxyl Value of the Polyester Resin Constituting the Toner Particle>

The acid value/hydroxyl value of the polyester resin constituting the toner particle is measured according to the procedure in JIS K 0070.

<Measurement of the Average Particle Diameter on a Volume Basis (D50) of the Toner Particle>

The average particle diameter on a volume basis (D50) of the toner particle is measured using a laser diffraction/scattering particle size distribution analyzer (LA-950, Horiba, Ltd.).

### EXAMPLES

The present invention is described in detail in the following using examples and comparative examples, but the present invention is not limited to or by these examples and comparative examples. Unless specifically indicated otherwise, “parts” and “%” denote, respectively, “mass parts” and “mass %”.

### Polyester Resin 1 Production Example

| Ethylene oxide adduct on bisphenol A | 100 mass parts |
|---|---|
| (average number of moles of ethylene oxide addition = 2.1 moles) | |
| Terephthalic acid | 57 mass parts |
| Trimellitic anhydride | 10 mass parts |

100 mass parts of a mixture of these monomers was introduced into a four-neck flask; a pressure-reduction system, water separator, nitrogen gas introduction system, temperature measurement device, and stirrer were mounted; and stirring was performed at 160° C. under a nitrogen atmosphere. This was followed by the introduction of 0.3 mass parts of dibutyltin oxide, and a condensation polymerization reaction was run while reducing the pressure in the vessel to 7,000 Pa and gradually raising the temperature to 210° C.

After the completion of the reaction, the product was removed from the vessel, cooled, and pulverized to obtain polyester resin 1.

### Polyester Resin 2 Production Example

| Ethylene oxide adduct on bisphenol A | 100 mass parts |
|---|---|
| (average number of moles of ethylene oxide addition = 2.1 moles) | |
| Terephthalic acid | 50 mass parts |
| Trimellitic anhydride | 17 mass parts |

The polyester resin 2 was obtained by carrying out a condensation polymerization reaction as in the Polyester Resin 1 Production Example, but using 100 mass parts of a mixture of the monomers indicated above.

### Polyester Resin 3 Production Example

| Ethylene oxide adduct on bisphenol A | 100 mass parts |
|---|---|
| (average number of moles of ethylene oxide addition = 2.1 moles) | |
| Terephthalic acid | 60 mass parts |
| Trimellitic anhydride | 7 mass parts |

The polyester resin 3 was obtained by carrying out a condensation polymerization reaction as in the Polyester Resin 1 Production Example, but using 100 mass parts of a mixture of the monomers indicated above.

### Polyester Resin 4 Production Example

| | |
|---|---|
| Ethylene oxide adduct on bisphenol A | 50 mass parts |

(average number of moles of ethylene oxide addition = 1.5 moles)

| | |
|---|---|
| Ethylene glycol | 12 mass parts |
| Terephthalic acid | 35 mass parts |
| Trimellitic anhydride | 6 mass parts |

The polyester resin 4 was obtained by carrying out a condensation polymerization reaction as in the Polyester Resin 1 Production Example, but using 100 mass parts of a mixture of the monomers indicated above.

### Resin 5 Production Example

| | |
|---|---|
| Ethylene oxide adduct on bisphenol A | 80 mass parts |

(average number of moles of ethylene oxide addition = 1.5 moles)

| | |
|---|---|
| Ethylene glycol | 5 mass parts |
| Terephthalic acid | 56 mass parts |
| Trimellitic anhydride | 1 mass part |

The polyester resin 5 was obtained by carrying out a condensation polymerization reaction as in the Polyester Resin 1 Production Example, but using 100 mass parts of a mixture of the monomers indicated above.

### Polyester Resin 6 Production Example

| | |
|---|---|
| Ethylene oxide adduct on bisphenol A | 50 mass parts |

(average number of moles of ethylene oxide addition = 2.1 moles)

| | |
|---|---|
| Ethylene glycol | 12 mass parts |
| Terephthalic acid | 17 mass parts |
| Trimellitic anhydride | 25 mass parts |

The polyester resin 6 was obtained by carrying out a condensation polymerization reaction as in the Polyester Resin 1 Production Example, but using 100 mass parts of a mixture of the monomers indicated above.

### Polyester Resin 7 Production Example

| | |
|---|---|
| Ethylene oxide adduct on bisphenol A | 55 mass parts |

(average number of moles of ethylene oxide addition = 0.8 moles)

| | |
|---|---|
| Ethylene glycol | 11 mass parts |
| Terephthalic acid | 18 mass parts |
| Trimellitic anhydride | 26 mass parts |

The polyester resin 7 was obtained by carrying out a condensation polymerization reaction as in the Polyester Resin 1 Production Example, but using 100 mass parts of a mixture of the monomers indicated above.

### Polyester Resin 8 Production Example

| | |
|---|---|
| Ethylene oxide adduct on bisphenol A | 60 mass parts |

(average number of moles of ethylene oxide addition = 1.5 moles)

| | |
|---|---|
| Ethylene glycol | 10 mass parts |
| Terephthalic acid | 19 mass parts |
| Trimellitic anhydride | 28 mass parts |

The polyester resin 8 was obtained by carrying out a condensation polymerization reaction as in the Polyester Resin 1 Production Example, but using 100 mass parts of a mixture of the monomers indicated above.

### Polyester Resin 9 Production Example

| | |
|---|---|
| Ethylene oxide adduct on bisphenol A | 55 mass parts |

(average number of moles of ethylene oxide addition = 2.1 moles)

| | |
|---|---|
| Ethylene glycol | 11 mass parts |
| Terephthalic acid | 67 mass parts |

The polyester resin 9 was obtained by carrying out a condensation polymerization reaction as in the Polyester Resin 1 Production Example, but using 100 mass parts of a mixture of the monomers indicated above.

### Polyester Resin 10 Production Example

| | |
|---|---|
| Ethylene oxide adduct on bisphenol A | 55 mass parts |

(average number of moles of ethylene oxide addition = 2.1 moles)

| | |
|---|---|
| Ethylene glycol | 11 mass parts |
| Terephthalic acid | 13 mass parts |
| Trimellitic anhydride | 31 mass parts |

The polyester resin 10 was obtained by carrying out a condensation polymerization reaction as in the Polyester Resin 1 Production Example, but using 100 mass parts of a mixture of the monomers indicated above.

### Polyester Resin 11 Production Example

| | |
|---|---|
| Ethylene oxide adduct on bisphenol A | 45 mass parts |

(average number of moles of ethylene oxide addition = 2.1 moles)

| | |
|---|---|
| Ethylene glycol | 14 mass parts |
| Terephthalic acid | 16 mass parts |
| Trimellitic anhydride | 24 mass parts |

The polyester resin 11 was obtained by carrying out a condensation polymerization reaction as in the Polyester Resin 1 Production Example, but using 100 mass parts of a mixture of the monomers indicated above.

### Polyester Resin 12 Production Example

| | |
|---|---|
| Ethylene glycol | 25 mass parts |
| Terephthalic acid | 14 mass parts |
| Trimellitic anhydride | 3 mass parts |

The polyester resin 12 was obtained by carrying out a condensation polymerization reaction as in the Polyester Resin 1 Production Example, but using 100 mass parts of a mixture of the monomers indicated above.

### Polyester Resin 13 Production Example

| Ethylene oxide adduct on bisphenol A | 100 mass parts |
|---|---|
| (average number of moles of ethylene oxide addition = 2.1 moles) | |
| Terephthalic acid | 50 mass parts |
| Trimellitic anhydride | 17 mass parts |

The polyester resin 13 was obtained by carrying out a condensation polymerization reaction as in the Polyester Resin 1 Production Example, but using 100 mass parts of a mixture of the monomers indicated above.

### Pigment Dispersing Agent 1 Synthesis Example

8.5 mass parts of N-methyldiethanolamine was combined with 100 mass parts of a toluene solution (50% solids fraction) of an isocyanate group-bearing polycarbodiimide compound having a carbodiimide equivalent of 262, and this was held for 3 hours at approximately 100° C. to react the isocyanate group with the hydroxyl group.

This was followed by the introduction of 39.6 mass parts of an ϵ-caprolactone self-polycondensate having a number-average molecular weight of 8,500 and having the carboxy group in terminal position and holding for 2 hours at approximately 80° C. to react the carbodiimide group and the carboxy group. The toluene was then distillatively removed under reduced pressure to obtain a pigment dispersing agent 1 (100% solids fraction) having a number-average molecular weight of approximately 13,000.

### Liquid Developer 1 Production Example [Pigment Dispersion Step]

| | |
|---|---|
| Pigment (C.I. Pigment Blue 2, | 10 mass parts, |
| Dainichiseika Color & | |
| Chemicals Mfg. Co., Ltd.) | |
| pigment dispersing agent 1 | 10 mass parts, and |
| tetrahydrofuran (THF) | 80 mass parts |

were mixed and a dispersion was obtained by stirring and mixing with a bead mill using glass beads having a diameter of 0.5 mm.

| | |
|---|---|
| The resulting dispersion | 100 mass parts, |
| preliminarily prepared mixture of polyester | 120 mass parts, and |
| resin 1 and tetrahydrofuran in a 1:1 mass ratio | |
| Ajisper PB-817, Ajinomoto Fine-Techno Co., Inc. | 5 mass parts |

were mixed using a high-speed disperser (T. K. Robomix/T. K. Homodisper Model 2.5 impeller) and were mixed while stirring at 40° C. to obtain a pigment dispersion 1.

[Mixing Step]

A mixture 1 was obtained by adding 140 mass parts of dodecyl vinyl ether (DDVE), i.e., a nonaqueous solution, in small portions while subjecting the obtained pigment dispersion 1 to high-speed stirring (20,000 rpm) using a homogenizer (Ultra-Turrax T50, IKA).

[Distillative Removal Step]

The resulting mixture 1 was transferred to a recovery flask and the THF was completely distilled off at 50° C. using a rotary evaporator from Tokyo Rikakikai Co., Ltd. while carrying out ultrasound dispersion, to yield a toner particle dispersion 1 containing toner particles in a nonaqueous solution.

The obtained toner particle dispersion 1 (10 mass parts) was subjected to centrifugal separation; the supernatant was removed by decantation and was replaced by fresh DDVE in the same mass as the supernatant that had been removed; and redispersion was carried out.

This was followed by the addition of 0.10 mass parts of Lecinol S-10 (hydrogenated lecithin, Nikko Chemicals Co., Ltd.), 90 mass parts of dipropylene glycol divinyl ether, i.e., a nonaqueous solution, 0.30 mass parts of the photopolymerization initiator given by the following formula (A-1), and 1 mass part of KAYACURE-DETX-S (Nippon Kayaku Co., Ltd.) to give a liquid developer 1.

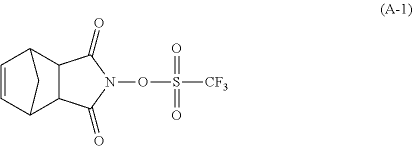 [SMILES: O=C1C2C3C=CC(C3)C2C(=O)N1OS(=O)(=O)C(F)(F)F]

The content (referred to as A in Table 1) of the trimellitic acid derived-monomer unit in the total acid component-derived monomer unit constituting the polyester resin in the toner particle in liquid developer 1 was 15.3 mol %.

The content (referred to as B in Table 1) of the monomer unit derived from the ethylene oxide adduct on bisphenol A in the total alcohol component-derived monomer unit constituting the polyester resin was 100.0 mol %.

The average number of moles of ethylene oxide addition (referred to as C in Table 1) in the ethylene oxide adduct on bisphenol A was 2.1 moles.

The polyester resin constituting the toner particle had a weight-average molecular weight of 17,000, a content of molecular weight equal to or less than 1,000 of 0.5 mass %, an acid value of 11.5 mg KOH/g, and a hydroxyl value of 48.0 mg KOH/g.

The average circularity of the toner particle was 0.975, and the average particle diameter on a volume basis (D50) of the toner particle was 1.1 μm.

### Liquid Developer 2 Production Example

A liquid developer 2 was obtained proceeding as in the Liquid Developer 1 Production Example, but using

| | |
|---|---|
| the resulting dispersion | 100 mass parts, |
| a preliminarily prepared mixture of polyester | 125 mass parts, and |
| resin 2 and tetrahydrofuran in a 1:1 mass ratio | |
| Ajisper PB-817, Ajinomoto Fine-Techno Co., Inc. | 5 mass parts |

in [Pigment Dispersion Step] in the Liquid Developer 1 Production Example.

The content (referred to as A in Table 1) of the trimellitic acid derived-monomer unit in the total acid component-derived monomer unit constituting the polyester resin in the toner particle in liquid developer 2 was 24.6 mol %.

The content (referred to as B in Table 1) of the monomer unit derived from the ethylene oxide adduct on bisphenol A in the total alcohol component-derived monomer unit constituting the polyester resin was 100.0 mol %.

The average number of moles of ethylene oxide addition in the ethylene oxide adduct on bisphenol A was 2.1 moles.

The polyester resin constituting the toner particle had a weight-average molecular weight of 18,500, a content of molecular weight equal to or less than 1,000 of 0.6 mass %, an acid value of 18.0 mg KOH/g, and a hydroxyl value of 50.0 mg KOH/g.

The average circularity of the toner particle was 0.970, and the average particle diameter on a volume basis (D50) of the toner particle was 1.0 μm.

### Liquid Developer 3 Production Example

A liquid developer 3 was obtained proceeding as in the Liquid Developer 1 Production Example, but using

| | |
|---|---|
| the resulting dispersion | 100 mass parts, |
| a preliminarily prepared mixture of polyester | 120 mass parts, and |
| resin 3 and tetrahydrofuran in a 1:1 mass ratio | |
| Ajisper PB-817, Ajinomoto Fine-Techno Co., Inc. | 5 mass parts |

### in [Pigment Dispersion Step] in the Liquid Developer 1 Production Example.

The content (referred to as A in Table 1) of the trimellitic acid derived-monomer unit in the total acid component-derived monomer unit constituting the polyester resin in the toner particle in liquid developer 3 was 10.2 mol %.

The content (referred to as B in Table 1) of the monomer unit derived from the ethylene oxide adduct on bisphenol A in the total alcohol component-derived monomer unit constituting the polyester resin was 100.0 mol %.

The average number of moles of ethylene oxide addition in the ethylene oxide adduct on bisphenol A was 2.1 moles.

The polyester resin constituting the toner particle had a weight-average molecular weight of 16,600, a content of molecular weight equal to or less than 1,000 of 0.3 mass %, an acid value of 9.8 mg KOH/g, and a hydroxyl value of 46.5 mg KOH/g.

The average circularity of the toner particle was 0.972, and the average particle diameter on a volume basis (D50) of the toner particle was 1.2 μm.

### Liquid Developer 4 Production Example

A liquid developer 4 was obtained proceeding as in the Liquid Developer 1 Production Example, but using

| | |
|---|---|
| the resulting dispersion | 100 mass parts, |
| a preliminarily prepared mixture of polyester | 120 mass parts, and |
| resin 4 and tetrahydrofuran in a 1:1 mass ratio | |
| Ajisper PB-817, Ajinomoto Fine-Techno Co., Inc. | 5 mass parts |

### in [Pigment Dispersion Step] in the Liquid Developer 1 Production Example.

The content (referred to as A in Table 1) of the trimellitic acid derived-monomer unit in the total acid component-derived monomer unit constituting the polyester resin in the toner particle in liquid developer 4 was 15.8 mol %.

The content (referred to as B in Table 1) of the monomer unit derived from the ethylene oxide adduct on bisphenol A in the total alcohol component-derived monomer unit constituting the polyester resin was 51.3 mol %.

The average number of moles of ethylene oxide addition in the ethylene oxide adduct on bisphenol A was 1.5 moles.

The polyester resin constituting the toner particle had a weight-average molecular weight of 18,100, a content of molecular weight equal to or less than 1,000 of 0.4 mass %, an acid value of 12.0 mg KOH/g, and a hydroxyl value of 47.5 mg KOH/g.

The average circularity of the toner particle was 0.965, and the average particle diameter on a volume basis (D50) of the toner particle was 1.2 μm.

### Liquid Developer 5 Production Example

A liquid developer 5 was obtained proceeding as in the Liquid Developer 1 Production Example, but using

| | |
|---|---|
| the resulting dispersion | 100 mass parts, |
| a preliminarily prepared mixture of polyester | 130 mass parts, and |
| resin 5 and tetrahydrofuran in a 1:1 mass ratio | |
| Ajisper PB-817, Ajinomoto Fine-Techno Co., Inc. | 6 mass parts |
| in [Pigment Dispersion Step] in the Liquid | |
| Developer 1 Production Example. | |

The content (referred to as A in Table 1) of the trimellitic acid derived-monomer unit in the total acid component-derived monomer unit constituting the polyester resin in the toner particle in liquid developer 5 was 2.1 mol %.

The content (referred to as B in Table 1) of the monomer unit derived from the ethylene oxide adduct on bisphenol A in the total alcohol component-derived monomer unit constituting the polyester resin was 80.2 mol %.

The average number of moles of ethylene oxide addition in the ethylene oxide adduct on bisphenol A was 1.5 moles.

The polyester resin constituting the toner particle had a weight-average molecular weight of 17,200, a content of molecular weight equal to or less than 1,000 of 0.1 mass %, an acid value of 10.2 mg KOH/g, and a hydroxyl value of 15.3 mg KOH/g.

The average circularity of the toner particle was 0.970, and the average particle diameter on a volume basis (D50) of the toner particle was 1.0 μm.

### Liquid Developer 6 Production Example

A liquid developer 6 was obtained proceeding as in the Liquid Developer 1 Production Example, but using

| | |
|---|---|
| the resulting dispersion | 100 mass parts, |
| a preliminarily prepared mixture of polyester | 120 mass parts, and |
| resin 6 and tetrahydrofuran in a 1:1 mass ratio | |
| Ajisper PB-817, Ajinomoto Fine-Techno Co., Inc. | 5 mass parts |

### in [Pigment Dispersion Step] in the Liquid Developer 1 Production Example.

The content (referred to as A in Table 1) of the trimellitic acid derived-monomer unit in the total acid component-derived monomer unit constituting the polyester resin in the toner particle in liquid developer 6 was 54.8 mol %.

The content (referred to as B in Table 1) of the monomer unit derived from the ethylene oxide adduct on bisphenol A in the total alcohol component-derived monomer unit constituting the polyester resin was 50.6 mol %.

The average number of moles of ethylene oxide addition in the ethylene oxide adduct on bisphenol A was 2.1 moles.

The polyester resin constituting the toner particle had a weight-average molecular weight of 16,900, a content of molecular weight equal to or less than 1,000 of 2.1 mass %, an acid value of 25.2 mg KOH/g, and a hydroxyl value of 60.0 mg KOH/g.

The average circularity of the toner particle was 0.972, and the average particle diameter on a volume basis (D50) of the toner particle was 1.3 μm.

### Liquid Developer 7 Production Example

A liquid developer 7 was obtained proceeding as in the Liquid Developer 1 Production Example, but using

| | |
|---|---|
| the resulting dispersion | 100 mass parts, |
| a preliminarily prepared mixture of polyester | 115 mass parts, and |
| resin 7 and tetrahydrofuran in a 1:1 mass ratio | |
| Ajisper PB-817, Ajinomoto Fine-Techno Co., Inc. | 5 mass parts |

### in [Pigment Dispersion Step] in the Liquid Developer 1 Production Example.

The content (referred to as A in Table 1) of the trimellitic acid derived-monomer unit in the total acid component-derived monomer unit constituting the polyester resin in the toner particle in liquid developer 7 was 56.6 mol %.

The content (referred to as B in Table 1) of the monomer unit derived from the ethylene oxide adduct on bisphenol A in the total alcohol component-derived monomer unit constituting the polyester resin was 55.1 mol %.

The average number of moles of ethylene oxide addition in the ethylene oxide adduct on bisphenol A was 0.8 moles.

The polyester resin constituting the toner particle had a weight-average molecular weight of 17,400, a content of molecular weight equal to or less than 1,000 of 1.0 mass %, an acid value of 24.8 mg KOH/g, and a hydroxyl value of 59.2 mg KOH/g.

The average circularity of the toner particle was 0.974, and the average particle diameter on a volume basis (D50) of the toner particle was 1.3 μm.

### Liquid Developer 8 Production Example

A liquid developer 8 was obtained proceeding as in the Liquid Developer 1 Production Example, but using

| | |
|---|---|
| the resulting dispersion | 100 mass parts, |
| a preliminarily prepared mixture of polyester | 115 mass parts, and |
| resin 8 and tetrahydrofuran in a 1:1 mass ratio | |
| Solsperse S-13940, Lubrizol Japan Ltd. | 6 mass parts |

### in [Pigment Dispersion Step] in the Liquid Developer 1 Production Example.

The content (referred to as A in Table 1) of the trimellitic acid derived-monomer unit in the total acid component-derived monomer unit constituting the polyester resin in the toner particle in liquid developer 8 was 55.8 mol %.

The content (referred to as B in Table 1) of the monomer unit derived from the ethylene oxide adduct on bisphenol A in the total alcohol component-derived monomer unit constituting the polyester resin was 58.2 mol %.

The average number of moles of ethylene oxide addition in the ethylene oxide adduct on bisphenol A was 1.5 moles.

The polyester resin constituting the toner particle had a weight-average molecular weight of 18,100, a content of molecular weight equal to or less than 1,000 of 5.3 mass %, an acid value of 26.1 mg KOH/g, and a hydroxyl value of 61.0 mg KOH/g.

The average circularity of the toner particle was 0.948, and the average particle diameter on a volume basis (D50) of the toner particle was 0.9 μm.

### Liquid Developer 9 Production Example

A liquid developer 9 was obtained proceeding as in the Liquid Developer 1 Production Example, but using

| | |
|---|---|
| the resulting dispersion | 100 mass parts, |
| a preliminarily prepared mixture of polyester | 120 mass parts, and |
| resin 9 and tetrahydrofuran in a 1:1 mass ratio | |
| Ajisper PB-817, Ajinomoto Fine-Techno Co., Inc. | 5 mass parts |

### in [Pigment Dispersion Step] in the Liquid Developer 1 Production Example.

The content (referred to as A in Table 1) of the trimellitic acid derived-monomer unit in the total acid component-derived monomer unit constituting the polyester resin in the toner particle in liquid developer 9 was 0.0 mol %.

The content (referred to as B in Table 1) of the monomer unit derived from the ethylene oxide adduct on bisphenol A in the total alcohol component-derived monomer unit constituting the polyester resin was 54.1 mol %.

The average number of moles of ethylene oxide addition in the ethylene oxide adduct on bisphenol A was 2.1 moles.

The polyester resin constituting the toner particle had a weight-average molecular weight of 17,100, a content of molecular weight equal to or less than 1,000 of 0.3 mass %, an acid value of 12.1 mg KOH/g, and a hydroxyl value of 14.3 mg KOH/g.

The average circularity of the toner particle was 0.971, and the average particle diameter on a volume basis (D50) of the toner particle was 1.3 μm.

### Liquid Developer 10 Production Example

A liquid developer 10 was obtained proceeding as in the Liquid Developer 1 Production Example, but using

| | |
|---|---|
| the resulting dispersion | 100 mass parts, |
| a preliminarily prepared mixture of polyester | 120 mass parts, and |
| resin 10 and tetrahydrofuran in a 1:1 mass ratio | |
| Ajisper PB-817, Ajinomoto Fine-Techno Co., Inc. | 6 mass parts |

### in [Pigment Dispersion Step] in the Liquid Developer 1 Production Example.

The content (referred to as A in Table 1) of the trimellitic acid derived-monomer unit in the total acid component-derived monomer unit constituting the polyester resin in the toner particle in liquid developer 10 was 62.1 mol %.

The content (referred to as B in Table 1) of the monomer unit derived from the ethylene oxide adduct on bisphenol A in the total alcohol component-derived monomer unit constituting the polyester resin was 52.8 mol %.

The average number of moles of ethylene oxide addition in the ethylene oxide adduct on bisphenol A was 2.1 moles.

The polyester resin constituting the toner particle had a weight-average molecular weight of 18,400, a content of molecular weight equal to or less than 1,000 of 6.4 mass %, an acid value of 25.8 mg KOH/g, and a hydroxyl value of 59.9 mg KOH/g.

The average circularity of the toner particle was 0.973, and the average particle diameter on a volume basis (D50) of the toner particle was 1.1 μm.

### Liquid Developer 11 Production Example

A liquid developer 11 was obtained proceeding as in the Liquid Developer 1 Production Example, but using

| | |
|---|---|
| the resulting dispersion | 100 mass parts, |
| a preliminarily prepared mixture of polyester | 120 mass parts, and |
| resin 11 and tetrahydrofuran in a 1:1 mass ratio | |
| Ajisper PB-817, Ajinomoto Fine-Techno Co., Inc. | 5 mass parts |

### in [Pigment Dispersion Step] in the Liquid Developer 1 Production Example.

The content (referred to as A in Table 1) of the trimellitic acid derived-monomer unit in the total acid component-derived monomer unit constituting the polyester resin in the toner particle in liquid developer 11 was 55.1 mol %.

The content (referred to as B in Table 1) of the monomer unit derived from the ethylene oxide adduct on bisphenol A in the total alcohol component-derived monomer unit constituting the polyester resin was 45.2 mol %.

The average number of moles of ethylene oxide addition in the ethylene oxide adduct on bisphenol A was 2.1 moles.

The polyester resin constituting the toner particle had a weight-average molecular weight of 17,800, a content of molecular weight equal to or less than 1,000 of 1.2 mass %, an acid value of 23.9 mg KOH/g, and a hydroxyl value of 58.0 mg KOH/g.

The average circularity of the toner particle was 0.972, and the average particle diameter on a volume basis (D50) of the toner particle was 1.2 μm.

### Liquid Developer 12 Production Example

A liquid developer 12 was obtained proceeding as in the Liquid Developer 1 Production Example, but using

| | |
|---|---|
| the resulting dispersion | 100 mass parts, |
| a preliminarily prepared mixture of polyester | 120 mass parts, and |
| resin 12 and tetrahydrofuran in a 1:1 mass ratio | |
| Ajisper PB-817, Ajinomoto Fine-Techno Co., Inc. | 5 mass parts |

### in [Pigment Dispersion Step] in the Liquid Developer 1 Production Example.

The content (referred to as A in Table 1) of the trimellitic acid derived-monomer unit in the total acid component-derived monomer unit constituting the polyester resin in the toner particle in liquid developer 12 was 16.2 mol %.

The content (referred to as B in Table 1) of the monomer unit derived from the ethylene oxide adduct on bisphenol A in the total alcohol component-derived monomer unit constituting the polyester resin was 0.0 mol %.

The polyester resin constituting the toner particle had a weight-average molecular weight of 18,200, a content of molecular weight equal to or less than 1,000 of 0.2 mass %, an acid value of 14.8 mg KOH/g, and a hydroxyl value of 28.0 mg KOH/g.

The average circularity of the toner particle was 0.968, and the average particle diameter on a volume basis (D50) of the toner particle was 1.2 μm.

### Liquid Developer 13 Production Example

### [Pigment Dispersion Step]

| | |
|---|---|
| Pigment | 10 mass parts, |
| (C.I. Pigment Blue 2, | |
| Dainichiseika Color & | |
| Chemicals Mfg. Co., Ltd.) | |
| pigment dispersing agent 1 | 10 mass parts, and |
| tetrahydrofuran (THF) | 80 mass parts |

were mixed and a dispersion was obtained by stirring and mixing with a bead mill using glass beads having a diameter of 0.5 mm.

| | |
|---|---|
| The resulting dispersion | 100 mass parts |
| A preliminarily prepared mixture | 120 mass parts |
| of polyester resin 13 and | |
| tetrahydrofuran in a 1:1 mass ratio | |
| Neogen SC-F | 10 mass parts |
| (Dai-ichi Kogyo Seiyaku Co., Ltd.) | |

This formulation was mixed; 100 mass parts of 1 mol/L aqueous ammonia was then added; while thoroughly stirring using a high-speed disperser (T. K. Robomix/T. K. Homodisper Model 2.5 impeller, PRIMIX Corporation) and holding the temperature of the mixture at 25° C., 80 mass parts of deionized water was added dropwise; and, while continuing to stir, an O/W emulsion, in which a resin material-containing dispersoid was dispersed, was obtained via a W/O emulsion by the addition of 20 mass parts of deionized water.

This O/W emulsion was then transferred to a stirred vessel and the temperature of the O/W emulsion was brought to 25° C., and coalesced particles were subsequently formed by carrying out coalescence of the dispersoid by the dropwise addition of 40 mass parts of a 5.0% aqueous sodium sulfate solution. Stirring was performed for 30 minutes after particle formation; 20 mass parts of deionized water was added; the coalesced particle-containing O/W emulsion was placed under reduced pressure; and the organic solvent was distillatively removed to obtain a toner particle dispersion.

A washing process was performed by carrying out solid-liquid separation on the obtained dispersion, then carrying out another redispersion in water (reslurrying), and repeating the solid-liquid separation.

A dry toner particle was then obtained by drying the obtained wet cake using a vacuum dryer.

Toner particle dispersion 13 was obtained by mixing the following for 24 hours using a sand mill: 20 mass parts of the dry toner particle obtained by the method described in the preceding, 80 mass parts of dodecyl vinyl ether (DDVE), i.e., a nonaqueous solution, and 4.5 mass parts of a toner particle dispersing agent (Ajisper PB-817, Ajinomoto Fine-Techno Co., Inc.).

The obtained toner particle dispersion 13 (10 mass parts) was subjected to centrifugal separation; the supernatant was removed by decantation and was replaced by fresh DDVE in the same mass as the supernatant that had been removed; and redispersion was carried out.

This was followed by the addition of 0.10 mass parts of Lecinol S-10 (hydrogenated lecithin, Nikko Chemicals Co., Ltd.), 90 mass parts of dipropylene glycol divinyl ether, i.e., a nonaqueous solution, 0.30 mass parts of the photopolymerization initiator given by the preceding formula (A-1), and 1 mass part of KAYACURE-DETX-S (Nippon Kayaku Co., Ltd.) to give a liquid developer 13.

The content (referred to as A in Table 1) of the trimellitic acid derived-monomer unit in the total acid component-derived monomer unit constituting the polyester resin in the toner particle in liquid developer 13 was 24.6 mol %.

The content (referred to as B in Table 1) of the monomer unit derived from the ethylene oxide adduct on bisphenol A in the total alcohol component-derived monomer unit constituting the polyester resin was 100.0 mol %.

The average number of moles of ethylene oxide addition in the ethylene oxide adduct on bisphenol A adduct was 2.1 moles.

The polyester resin constituting the toner particle had a weight-average molecular weight of 18,500, a content of molecular weight equal to or less than 1,000 of 0.6 mass %, an acid value of 18.0 mg KOH/g, and a hydroxyl value of 50.0 mg KOH/g.

The average circularity of the toner particle was 0.948, and the average particle diameter on a volume basis (D50) of the toner particle was 1.1 μm.

### Example 1

The liquid developer 1 was introduced into the image-forming apparatus shown in the figure and the on-drum dot reproducibility and on-paper image quality were evaluated.

The constitution of the image-forming apparatus used in this example is described in the following.

100 g of the liquid developer 1 was introduced, as a solution with a uniform concentration, into a liquid developer tank 16.

The liquid developer 1 is coated on the feed roller 15, which has been adjusted to a prescribed potential, and is transported to the development roller 13. The liquid developer 1 transferred to the development roller 13 is adjusted by the squeegee roller 14 to a desired developer concentration (25 to 35 mass %) and is transported to the development nip between the development roller 13 and the photosensitive drum 10.

An amorphous silicon drum was used in this example for the photosensitive drum 10, and its surface was charged to −600 V by the charging device 11 upstream from the development nip. After charging, a 1200-dpi 1 dot-1 space latent image was formed by the exposure device 12 so the potential of the image area was brought to −200 V. The peripheral velocity of the photosensitive drum 10 was 700 mm/s.

A bias of −400 V is applied to the development roller 13 and the negatively charged developer is selectively transferred to the image area. The carrier liquid is separated at the development nip to both the development roller 13 and the photosensitive drum 10. Thus, transport to downstream processing is carried out while the developer concentration increases.

A voltage of +200 V was applied to the intermediate transfer roller 17 to induce primary transfer of the developer developed onto the latent image area on the photosensitive drum 10.

The toner particles and carrier liquid remaining on the photosensitive drum 10 are scraped off by the cleaning blade 21.

A voltage of +1,000 V was applied to the secondary transfer roller 18 to induce secondary transfer of the developer on the intermediate transfer roller 17 to the media 20, e.g., paper, supported on the secondary transfer roller 18.

The developer that has undergone secondary transfer onto the media is accompanied by a small amount of the carrier liquid, and the image is fixed on the media by exposure to ultraviolet radiation in order to cause ultraviolet curing of the carrier liquid.

An ultraviolet irradiation device having an irradiation peak in the wavelength range of 385±5 nm was used for the curing lamp 19 in this example. The fixing step was carried out by passing the media under this curing lamp 19.

The dot reproducibility on the photosensitive drum 10 was evaluated as follows.

The image-forming apparatus was stopped prior to transfer, to the intermediate transfer roller 17, of the developer developed onto the photosensitive drum 10 from the development roller 13. The photosensitive drum 10 was then promptly removed from the apparatus, and the image on the photosensitive drum 10 was observed using a VHX-5000 digital microscope (KEYENCE Corporation) and an evaluation was performed using the following criteria.

### (Evaluation Criteria)

A: the dots are uniform and chipping is entirely absent
B: the dots are independent and defects such as scattering are also absent
C: dots can be recognized
D: regions in which dots cannot be recognized are frequently seen

In this example, which used liquid developer 1, the dots on the photosensitive drum 10 were highly uniform and chipping was completely absent, and this corresponded to A according to the evaluation criteria indicated above.

In addition, the separately prepared on-paper fixed image was also smooth and very uniform and the image quality was excellent.

### Example 2

Proceeding as in Example 1, the obtained liquid developer 2 was introduced into the image-forming apparatus shown in the figure and the dot reproducibility and on-paper fixed image were evaluated.

According to the results, the dot reproducibility was superior, as in Example 1, and an evaluation of A was rendered.

The on-paper fixed image was also excellent, as in Example 1.

### Example 3

Proceeding as in Example 1, the obtained liquid developer 3 was introduced into the image-forming apparatus shown in the figure and the dot reproducibility and on-paper fixed image were evaluated.

According to the results, the dot reproducibility was superior, as in Example 1, and an evaluation of A was rendered.

The on-paper fixed image was also excellent, as in Example 1.

### Example 4

Proceeding as in Example 1, the obtained liquid developer 4 was introduced into the image-forming apparatus shown in the figure and the dot reproducibility and on-paper fixed image were evaluated.

While the results were inferior to those in Examples 1 to 3, toner scattering into nonimage areas did not occur and the dots were independent and an evaluation of B was made.

The on-paper fixed image also was not rough and a uniform image quality was present.

### Example 5

Proceeding as in Example 1, the obtained liquid developer 5 was introduced into the image-forming apparatus shown in the figure and the dot reproducibility and on-paper fixed image were evaluated.

While the results were inferior to those in Examples 1 to 3, the dot reproducibility was excellent and an evaluation of B was made.

The on-paper fixed image also was not rough and a uniform image quality was present.

### Example 6

Proceeding as in Example 1, the obtained liquid developer 6 was introduced into the image-forming apparatus shown in the figure and the dot reproducibility and on-paper fixed image were evaluated.

While the results were inferior to those in Examples 1 to 3, the dot reproducibility was excellent and an evaluation of B was made.

The on-paper fixed image also was not rough and a uniform image quality was present.

### Example 7

Proceeding as in Example 1, the obtained liquid developer 7 was introduced into the image-forming apparatus shown in the figure and the dot reproducibility and on-paper fixed image were evaluated.

The results were inferior to those in Examples 1 to 6, but at a level at which dots could be recognized and an evaluation of C was made.

The on-paper fixed image also had a uniform image quality that was unproblematic from a practical standpoint.

### Comparative Example 1

Proceeding as in Example 1, the obtained liquid developer 8 was introduced into the image-forming apparatus shown in the figure and the dot reproducibility and on-paper fixed image were evaluated.

According to the results, dots substantially could not be recognized and an evaluation of D was made.

The on-paper fixed image was also inferior to that in Examples 1 to 7.

### Comparative Example 2

Proceeding as in Example 1, the obtained liquid developer 9 was introduced into the image-forming apparatus shown in the figure and the dot reproducibility and on-paper fixed image were evaluated.

According to the results, the toner particles were scattered out at a level at which dots substantially could not be recognized, and an evaluation of D was made.

The on-paper fixed image was also inferior to that in Examples 1 to 7.

### Comparative Example 3

Proceeding as in Example 1, the obtained liquid developer 10 was introduced into the image-forming apparatus shown in the figure and the dot reproducibility and on-paper fixed image were evaluated.

According to the results, the toner particles were scattered out at a level at which dots substantially could not be recognized, and an evaluation of D was made.

The on-paper fixed image was also inferior to that in Examples 1 to 7.

### Comparative Example 4

Proceeding as in Example 1, the obtained liquid developer 11 was introduced into the image-forming apparatus shown in the figure and the dot reproducibility and on-paper fixed image were evaluated.

According to the results, dot chipping and toner particle scattering were frequently observed and an evaluation of D was rendered.

The on-paper fixed image was also inferior to that in Examples 1 to 7.

### Comparative Example 5

Proceeding as in Example 1, the obtained liquid developer 12 was introduced into the image-forming apparatus shown in the figure and the dot reproducibility and on-paper fixed image were evaluated.

According to the results, the dots could not be reproduced at all and an evaluation of D was made.

The on-paper fixed image was also inferior to that in Examples 1 to 7.

### Comparative Example 6

Proceeding as in Example 1, the obtained liquid developer 13 was introduced into the image-forming apparatus shown in the figure and the dot reproducibility and on-paper fixed image were evaluated.

According to the results, dot chipping was frequently observed and an evaluation of D was made. Coarse toner particles were also frequently observed.

In addition, roughness was frequently observed in the on-paper fixed image, which was substantially inferior to those in Examples 1 to 7.

Table 1 gives the properties and the results of the dot reproducibility evaluations for the liquid developers used in the preceding examples and comparative examples.

TABLE 1

| | | A | B | C | Average circularity | Dot |
|---|---|---|---|---|---|---|
| | | (mol %) | (mol %) | (mol %) | of toner particle | reproducibility |
| Example 1 | Liquid developer 1 | 15.3 | 100.0 | 2.1 | 0.975 | A |
| Example 2 | Liquid developer 2 | 24.6 | 100.0 | 2.1 | 0.970 | A |
| Example 3 | Liquid developer 3 | 10.2 | 100.0 | 2.1 | 0.972 | A |
| Example 4 | Liquid developer 4 | 15.8 | 51.3 | 1.5 | 0.965 | B |
| Example 5 | Liquid developer 5 | 2.1 | 80.2 | 1.5 | 0.970 | B |
| Example 6 | Liquid developer 6 | 54.8 | 50.6 | 2.1 | 0.972 | B |
| Example 7 | Liquid developer 7 | 56.6 | 55.1 | 0.8 | 0.974 | C |
| Comparative Example 1 | Liquid developer 8 | 55.8 | 58.2 | 1.5 | 0.948 | D |
| Comparative Example 2 | Liquid developer 9 | 0.0 | 54.1 | 2.1 | 0.971 | D |
| Comparative Example 3 | Liquid developer 10 | 62.1 | 52.8 | 2.1 | 0.973 | D |
| Comparative Example 4 | Liquid developer 11 | 55.1 | 45.2 | 2.1 | 0.972 | D |
| Comparative Example 5 | Liquid developer 12 | 16.2 | 0.0 | — | 0.968 | D |
| Comparative Example 6 | Liquid developer 13 | 24.6 | 100.0 | 2.1 | 0.948 | D |

In Table 1,

A represents the content (mol %) of the monomer unit derived from trimellitic acid in the total acid component-derived monomer unit constituting the polyester resin;

B represents the content (mol %) of the monomer unit derived from the ethylene oxide adduct on bisphenol A in the total alcohol component-derived monomer unit constituting the polyester resin; and

C represents the average number of moles of ethylene oxide addition (moles) in the ethylene oxide adduct on bisphenol A.

The present invention can thus provide a liquid developer that exhibits an excellent electrostatic latent image reproducibility and yields a high-quality image and also can provide a method for producing the liquid developer.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A liquid developer comprising a toner particle that contains a polyester resin and a pigment and comprising a carrier liquid comprising a nonaqueous solution, wherein
the polyester resin contains, as an acid component, a monomer unit derived from trimellitic acid,
a content of the monomer unit derived from trimellitic acid in a total acid component-derived monomer unit constituting the polyester resin is from 2.0 mol % to 60.0 mol %,
the polyester resin contains, as an alcohol component, a monomer unit derived from an ethylene oxide adduct on bisphenol A,
a content of the monomer unit derived from the ethylene oxide adduct on bisphenol A in a total alcohol component-derived monomer unit constituting the polyester resin is from 50.0 mol % to 100.0 mol %,
an average circularity of the toner particle is at least 0.950, and
the carrier liquid comprising a nonaqueous solution further contains a polymerizable liquid monomer and a photopolymerization initiator represented by the following formula (1): 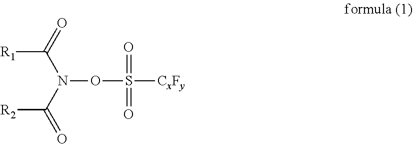
in formula (1), R₁ and R₂ are bonded to each other to form a ring structure, x represents an integer from 1 to 8, and y represents an integer from 3 to 17.

2. The liquid developer according to claim 1, wherein the average number of moles of ethylene oxide addition in the ethylene oxide adduct on bisphenol A is from 1.0 mole to 3.0 moles.

3. The liquid developer according to claim 1, wherein the polymerizable liquid monomer contains a vinyl ether compound.

4. The liquid developer according to claim 1, wherein
the liquid developer further comprises a toner particle dispersing agent, and
the toner particle dispersing agent contains a polymer that has a monomer unit represented by the following formula (A) and a monomer unit represented by the following formula (B),
K formula (A)
in formula (A), K is a monomer unit that has a primary amino group, and
Q formula (B)
in formula (B), Q is a monomer unit that has a possibly substituted alkyl group having at least 6 carbons, a possibly substituted cycloalkyl group having at least 6 carbons, a possibly substituted alkylene group having at least 6 carbons, or a possibly substituted cycloalkylene group having at least 6 carbons.

5. The liquid developer according to claim 4, wherein the toner particle dispersing agent contains a reaction product of a polyallylamine and a 12-hydroxystearic acid self-condensate.

6. A method for producing a liquid developer containing a toner particle that contains a polyester resin and a pigment and containing a carrier liquid comprising a nonaqueous solution, the method comprising:
a pigment dispersion step of preparing a pigment dispersion that contains the polyester resin, the pigment, and a solvent;
a mixing step of adding, to the pigment dispersion, the carrier liquid comprising the nonaqueous solution to prepare a mixture; and
a distillative removal step of distillatively removing the solvent from the mixture, wherein
the polyester resin contains, as an acid component, a monomer unit derived from trimellitic acid,
a content of the monomer unit derived from trimellitic acid in a total acid component-derived monomer unit constituting the polyester resin is from 2.0 mol % to 60.0 mol %,
the polyester resin contains, as an alcohol component, a monomer unit derived from an ethylene oxide adduct on bisphenol A,
a content of the monomer unit derived from the ethylene oxide adduct on bisphenol A in a total alcohol component-derived monomer unit constituting the polyester resin is from 50.0 mol % to 100.0 mol %,
an average circularity of the toner particle is at least 0.950, and
the carrier liquid comprising a nonaqueous solution further contains a polymerizable liquid monomer and a photopolymerization initiator represented by the following formula (1): 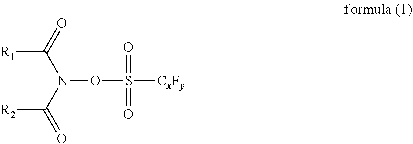
in formula (1), R₁ and R₂ are bonded to each other to form a ring structure, x represents an integer from 1 to 8, and y represents an integer from 3 to 17.

7. The method for producing a liquid developer according to claim 6, wherein the average number of moles of ethylene oxide addition in the ethylene oxide adduct on bisphenol A is from 1.0 mole to 3.0 moles.

8. The method for producing a liquid developer according to claim 6, wherein the polymerizable liquid monomer contains a vinyl ether compound.

9. The method for producing a liquid developer according to claim 6, wherein
the liquid developer further contains a toner particle dispersing agent, and
the toner particle dispersing agent contains a polymer that has a monomer unit represented by the following formula (A) and a monomer unit represented by the following formula (B),
K formula (A)
in formula (A), K is a monomer unit that has a primary amino group, and
Q formula (B)
in formula (B), Q is a monomer unit that has a possibly substituted alkyl group having at least 6 carbons, a possibly substituted cycloalkyl group having at least 6 carbons, a possibly substituted alkylene group having at least 6 carbons, or a possibly substituted cycloalkylene group having at least 6 carbons.

10. The method for producing a liquid developer according to claim 9, wherein the toner particle dispersing agent contains a reaction product of a polyallylamine and a 12-hydroxystearic acid self-condensate.
